(19) United States
(12) Patent Application Publication
(10) Pub. No.: US 2004/0038606 A1
(43) Pub. Date: Feb. 26, 2004

(54) Textile isolating material with integrated latent heat strorage material

(76) Inventors: Alan Field, Rosengarten (DE); Klaus Fieback, Berlin (DE); Dirk-Carsten Buttner, Berlin (DE); Soren Scholz, Hamburg (DE)

Correspondence Address: Martin A Farber, Suite 473, 866 United Nations Plaza, New York, NY, 10017, US

(21) Appl. No.: 10/258,554

(22) PCT Filed: May 3, 2001
(86) PCT No.: PCT/EP01/04898

(30) Foreign Application Priority Data
May 9, 2000 (DE) 10022287.0

(51) Int. Cl. B32B 27/20; B32B 5/16

(52) U.S. Cl. 442/74

(57) ABSTRACT

The invention relates to a multi-layered textile isolating material, such as isolating tissue or isolating woven material. The aim of the invention is to improve said isolating material, in particular with regard to thermal applications, whereby particles of latent heat storage material are arranged between the layers and said latent heat storage material is paraffin with an added thickener such as Kraton G.

The invention relates to a multi-ply textile spacer material, such as a woven spacer fabric or a loop-formingly knitted spacer fabric.

Spacer materials of this kind are known in multiple embodiments. See for example EP 339 227 B1/DE 31 39 402 A1 and U.S. Pat. No. 3,481,427. Reference is made in particular to DE 196 35 170 C1.

Such a spacer material can be formed not only from technical materials, especially glass fiber or carbon fiber, but especially from skin-friendly materials such as continuous filament polyester for example. Especially when the spacer material is to be moisture-conducting and absorbing, with a view to use on the human skin. More particularly, the distance-maintaining and also moisture-conducting threads can be formed of a plied three-component yarn. This plied three-component yarn can be formed of a monofil polyester pile thread, preferably in diameters <0.1 mm, a native fiber material or a filamentized synthetic fiber material and/or with particularly moisture-conducting cross section and generally at least of one fixing thread. The spacer material can have different faces. For one, a moisture-acquiring body-near face. This is preferably formed of a synthetic, non-absorbent textile material, and of a moisture-releasing, body-remote face which is preferably formed of an absorbent textile material.

Spacer materials of this kind are to be further improved. With regard to thermal applications in particular.

The invention accordingly proposes that particles of a latent heat storage material be disposed between the plies of the spacer material, the latent heat storage material being formed on the basis of a paraffin admixed with a thickener such as for example Karton G.

The particles are preferably unclothed “naked particles” which are directly composed of the material mentioned. The presence of a thickener prevents any leakage and spreading of the paraffin in the loaded state of the storage material, ie at the melting temperature of the paraffin. Nor, however, is there any need for a separate structure material, additionally included in the particles for example. In a preferred embodiment, the thickener can be a styrene block copolymer. Specifically a styrene block copolymer as obtainable under the trade name Kraton G. At any rate it is preferable to use diblock, triblock, radial block and/or multiblock copolymers here. This leads to a solid or jellylike structure for the latent heat storage material particle. It has been determined, in particular, that washing operations are unproblematical even when used on textiles. The latent heat storage material is not harmed thereby.

With regard to the paraffin, a very wide range of materials subsumed under “paraffin” are useful. In general, useful paraffins are solid paraffinic hydrocarbons (macro paraffins, intermediate paraffins, microcrystalline waxes). Solid, paraffinic hydrocarbons, as will be known, are generally obtained from vacuum distillation fractions by various technological separating steps which are responsible for a certain oil content. This oil content may perfectly well remain included. Useful paraffins further include synthetic paraffins which are obtained by the Fischer-Tropsch process. Such FT paraffins are predominantly composed of normal paraffins only. As a rule, more than 90% are N alkanes. The remainder is isoalkanes. The chain length ranges from C 30 to about C 100 coupled with a gradation (also known as solidification point) from about 860 to 105° C. In addition, however, there are also such FT paraffins having solidification points in the range from 30 to 80° C. For FT paraffins in general reference is made for example to A. Kühnle in “Fette, Seifen, Anstrichmittel 1982, pages 156 to 162.

The thickener can be added as required. A customary fraction is 10 to 15% based on the total mass of a particle described herein. What is crucial is that the paraffin does not become detached when subjected to wetness, especially and including in washing operations.

The working temperature, ie the temperature range at which heat is stored without increase in the temperature of the latent heat storage particle or is destored, can be predetermined through choice of the suitable paraffin. The melting point of the paraffin is of decisive importance here.

The addition of such latent heat storage material particles to the textile spacer material also results in a latent heat storage effect. As a result of the latent heat storage material being composed of small particles in each case, the threads which cross the space between the plies of the textile material are sufficient to hold it in place.

It is initially possible to make these latent heat storage material particles so small that they can pass through the customary mesh size of such an outer ply of a corresponding spacer material, for example by being forced or pressed through.

It is preferable, however, to use such a spacer material which has a ply which possesses openings which make it possible to introduce the particles through the openings. These openings can have been formed by weaving or formed-loop knitting.

It is then further preferable in this connection for the ply having such openings to be sealed off by a cover against the latent heat storage material particles falling out or forcing their way out.

The sealing can be achieved in various ways. For example by covering by means of a film or foil or by means of a close-meshed further textile. In this case, the film, foil or textile can also be adhered to the base material in various ways. In the case of the textile but also in the case of the film or foil, it can be stitched to the base material. Or else for example quilted in order thereby to create individual compartments as it were. These quilting stitches can pass through the spacer material in order that compartmentalization is made possible therein.

In addition, the covers can also have been laminated onto the spacer material. For example through a certain heating of the spacer material which includes thermoplastic fibers where appropriate and/or of the cover, which then, through subsequent rolling on or pressing on, locally enter a close bond, a welded fusion as it were. It is also possible for a customary adhesive bond to be provided.

The invention will now be more particularly described with reference to the accompanying drawing, which, however, merely depicts an illustrative embodiment. In the drawing,

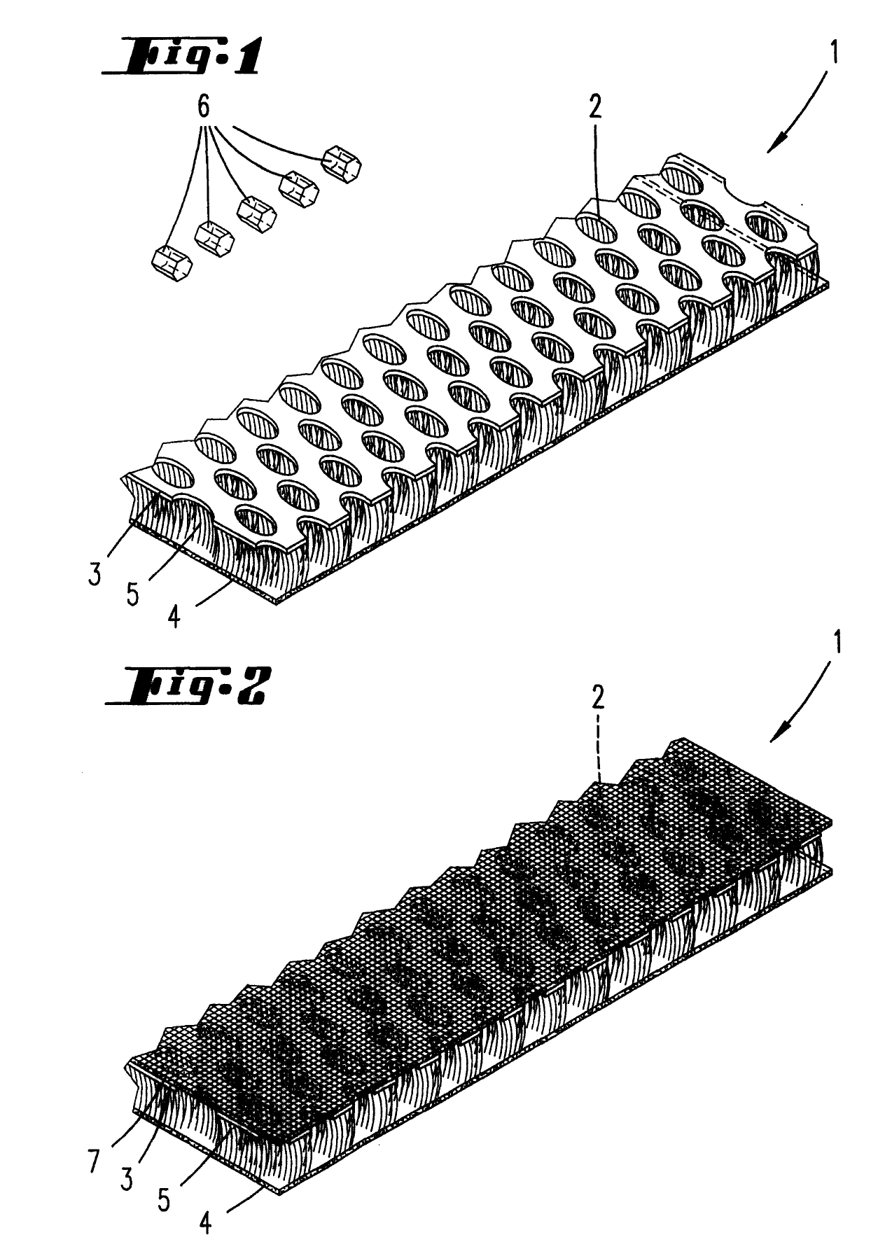

FIG. 1 shows a schematic perspective view of a loop-formingly knitted spacer fabric having loop-formingly knitted openings in one of the plies;

FIG. 2 shows the entity of FIG. 1 after latent heat body particles were introduced, with a cover.

What is depicted and described is initially with reference to FIG. 1 a textile spacer material 1 which has been produced by formed-loop knitting and which has loop-formingly knitted openings 2 in the upper ply 3. In addition there is a lower ply 4, which plies are spaced apart by spacer threads 5.

The openings 2, as likewise schematically indicated, have latent heat storage body particles 6 introduced into them.

In order that these latent heat storage body particles 6 may be permanently retained in the loop-formingly knitted spacer fabric, further provision has been made, cf. FIG. 2, for a cover 7. In the illustrative embodiment, this cover is formed of a loop-formingly close-knitted individual ply, substantially equal to the lower ply 4 with regard to its mesh openings. This cover 7 has been applied to the upper ply 3 of the loop-formingly knitted spacer fabric 1 by means of an adhesive which is not specifically depicted, and is permanently adhered thereby. The adhesive in question is an adhesive which is also washing machine proof.

All disclosed features are (by themselves) pertinent to the invention. The disclosure of the application hereby also fully incorporates the disclosure content of the related/accompanying priority documents (copy of prior application), partly with a view to including features of these documents in claims of the present application.

1. A multi-ply textile spacer material, in particular a woven spacer fabric or a loop-formingly knitted spacer fabric, characterized by particles of a latent storage material disposed between the plies, the latent storage material being paraffin admixed with a thickener such as Kraton G.

2. A spacer material according to claim 1 or in particular according thereto, characterized by the spacer material having at least one ply which possesses openings which enable the particles to penetrate through the openings.

3. A spacer material according to one or more of the preceding claims or in particular according thereto, characterized by the ply having openings being sealed by means of a cover against the particles falling out.

4. A spacer material according to one or more of the preceding claims or in particular according thereto, characterized by the cover being a film or foil.

5. A spacer material according to one or more of the preceding claims or in particular according thereto, characterized by the cover being a close-meshed textile ply.

6. A spacer material according to one or more of the preceding claims or in particular according thereto, characterized by the particles of the latent heat storage material having a largest dimension of 1 to 10 mm.
